(19) United States
(12) Patent Application Publication
(10) Pub. No.: US 2022/0222309 A1
(43) Pub. Date: Jul. 14, 2022

(54) Customizable Digital Replication And Transfer Application And Methods of Use Thereof

(71) Applicant: The.com Platform Inc, Boulder, CO (US)

(72) Inventors: Clarke McKinnon, Boulder, CO (US); Jeff McKinnon, Boulder, CO (US)

(21) Appl. No.: 17/575,967

(22) Filed: Jan. 14, 2022

Related U.S. Application Data
(60) Provisional application No. 63/137,299, filed on Jan. 14, 2021.

(51) Int. Cl. G06F 16/958; G06F 16/955; G06F 9/445

(52) U.S. Cl. CPC G06F 16/972; G06F 9/44526; G06F 16/9558

(57) ABSTRACT

The invention includes systems and methods for a customized digital replication and transfer system that can identify, replicate, modify and transfer select digital display components from one webpage to another or to a digital library.

### CROSS REFERENCE TO RELATED APPLICATION

This application claims the benefit of and priority to U.S. Provisional Application No. 63/137,299, filed Jan. 14, 2021. The entire specification and figures of the above-referenced application is hereby incorporated in their entirety by reference.

### TECHNICAL FIELD

The present invention relates to a systems and methods for the customized digital replication and transfer of digital content and information between two or more digital display functions. In one preferred embodiment, the invention relates to a novel executable application, such as a browser plugin configured for customized digital replication and transfer of digital content and information between two or more webpages.

### BACKGROUND

The vast majority of user engagement with the Internet, especially for the average individual, is through webpages and websites. A website is a set of related webpages served from a single web domain, and is hosted on at least one web server, accessible via a network such as the Internet or a private local area network through an Internet address known as a Uniform Resource Locator (URL). All publicly accessible websites collectively constitute the World Wide Web. Each webpage is a document, typically written in plain text interspersed with formatting instructions in a language, e.g., Hypertext Markup Language (HTML, XHTML).

In order to view information, a user launches an application, often referred to as a web browser, and navigates to a webpage through a search or a stored link. The web browser renders the page content according to its HTML markup instructions onto a display terminal, where the content and HTML markup instructions have been transported with the Hypertext Transfer Protocol (HTTP), which may optionally employ encryption (HTTP Secure, HTTPS) to provide security and privacy for the user of the webpage content. The URLs of the pages organize them into a hierarchy, although hyperlinking between them conveys the reader's perceived site structure and guides the reader's navigation of the site which generally includes a home page with most of the links to the site's web content, and a supplementary about, contact and link page. While some webpages may display results from searches, these search results are webpages or portions of webpages. With an estimated 200 million active websites, that is a vast amount of human resources applied to the design, layout, and configuration of those webpages.

At present, creating a website generally involves two primary jobs, the web designer, and the web developer, who often work closely together on a website. The web designer would typically be responsible for the visual aspect, which includes the layout, coloring, and typography of a webpage, while a web developer may be responsible for the technical aspects of the website and its function. For example, a web developer may use a variety of coding languages such as HTML, Cascading Style Sheets (CSS), JavaScript, PHP (a server-side scripting language), and Flash to create a site and its functionality. Particularly, in smaller organizations, one person will need the necessary skills for designing and programming the full webpage, while larger organizations may have a web designer responsible for the visual aspect alone. In other particular circumstances, other individuals may become involved during the creation of a website including, for example, graphic designers (to create visuals for the site such as logos, layouts and buttons), Internet marketing specialists (who help maintain web presence through strategic solutions targeting viewers), search engine optimizers (SEOs), who research/recommend website language to increase website visibility on search engines, Internet copywriters (to create the written content), and user experience (UX) designers (who address end-user design considerations).

As a result, establishing a website while being a major, often vital, element of an enterprise's or organization's strategy, can be an expensive proposition which is not helped by the need to support both desktop and mobile users as well as potentially supporting multiple languages to address users in different geographical regions. Due to the lower bandwidth, reduced display capabilities, and typically lower processor capabilities, a mobile webpage/website is generally less complex and less graphically intensive than a desktop webpage/website. Accordingly, over the past decade whilst professional design tools for webpages/websites have improved, a parallel development has occurred that is geared for the individual, the smaller enterprise, etc. wherein they can design and implement a web site and its webpages through the use of templates that are pre-configured, thereby removing the requirements of the user to understand web design and development tools. In many instances, these are discrete third party services but increasingly these are bundled as part of an overall package from specialty web-site development and hosting businesses.

However, this leaves the user with essentially two options. The first, with full creative control and flexibility is to exploit web developers and website development enterprises to generate exactly what they want. The second is to select a template from those offered by web-site development and hosting businesses and work within its constraints. The former is typically suited to established enterprises that can justify the marketing budget and quantify the return on investment whilst the latter is typically employed by small and new enterprises, individuals, etc., to establish a web presence without incurring significant costs for unknown return on investment.

Accordingly, it would be beneficial to provide users with the ability to establish a webpage and/or website with a design that they want within a platform technology that they find easy and intuitive to use.

It would be further beneficial for a user, when generating their webpage(s) and/or website(s) to be able to rapidly identify, replicate and transform digital design or structural elements from a first webpage and transfer them to second webpage rendered in a browser window, or in a separate application, or API interface rendered in a digital display, where they could be further modified or stored in a digital library for later use by a user, or accessed by others that may wish to apply them to a third webpage. In one embodiment, this separate application may be a cell-based computing system and website development platform as described in U.S. application Ser. No. 17/020,789. It would be further beneficial for the user to be able to accomplish these actions in a simple and seamless transition step.

As outlined below, the present inventors provide for a customized digital replication and transfer system, that may, in one preferred embodiment be used as a web development platform that addresses the shortcoming and problems with traditional systems described above.

### SUMMARY OF THE INVENTION

One aspect of the invention includes systems and methods for a customized digital replication and transfer system that can identify, replicate, modify and transfer select digital display components from one webpage to another or to a digital library. In this preferred aspect, an installed application, may be activated by a user on a digital device, such as a general use or virtual computer, tablet, or smartphone, and identify, replicate, modify and transfer select digital display components, such as text, video, images or other structure formats, from one webpage to another or to a digital library.

In another aspect, the invention includes systems and methods for a website development platform. In this preferred aspect, a user may execute an installed application on a digital device and identify, replicate, modify select digital display components from one webpage and transfer them to a second webpage thereby, which may be a new webpage or existing webpage. In this manner, a user can rapidly select preferred digital display components from one or more websites, or from a digital library of digital display components to rapidly build a new webpage or modify an existing webpage.

Another preferred embodiment may include a system, comprising digital device having a processor system configured to execute an application including a customized digital replication and transfer system comprising:
a processing system;
a memory configured to store a browser application and a plugin that interfaces with the browser application, wherein, upon being activated and executed by the processing system, the plugin is configured to:
   identify a digital display component (DDC) of a first webpage rendered within a browser window;
   replicate said DDC;
   transfer said DDC to a second application, a second webpage rendered within a browser window, or a digital library; and
   optionally modify said DDC;
wherein said steps optionally occur in a virtual environment; and
publish said DDC to a one or more webpages.

In another aspect a digital device comprises a general use computer, a tablet, a smartphone, or a virtual computer having a CDR plugin and the second application comprises an API, CDR plugin, or other plugin, or a cell-based computing system and website development platform as described in U.S. application Ser. No. 17/020,789. In another aspect a the DDC of a first webpage comprises DDC having one or more hyperlinks, which may be preserved, disabled, or replaced during a replication, transfer or modification step.

In another aspect a digital library comprises a digital library hosted on a server, or a cloud-based network. In another aspect a CDR plugin may automatically modify said DDC or allows a user to manually modify said DDC stored in a digital library or a digital device. In another aspect a CDR plugin may insert one or more DDCs into a template, optionally stored in a digital library or said digital device and where one or more DDC can be replicated on a plurality of webpages.

Other aspects and features of the present invention will become apparent to those ordinarily skilled in the art upon review of the following descriptions of specific embodiments of the invention in conjunction with the accompanying figures.

### BRIEF DESCRIPTION OF THE FIGURES

FIG. 1—is a generalized flowchart diagram of a customized digital replication and transfer system utilizing a Customizable Digital Replication (CDR) Plugin to replicate, optionally modify and transfer a Digital Display Component (DDC) from a first webpage to a second webpage.

FIG. 2—is a generalized flowchart diagram of a customized digital replication and transfer system utilizing a CDR Plugin to replicate, optionally modify and transfer a DDC from a first webpage to a second webpage.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

The inventive technology includes systems and methods for a customized digital replication and transfer system that can identify, replicate, modify and transfer select digital display components. In a preferred embodiment, inventive technology includes systems and methods for a customized digital replication and transfer system that can identify, replicate, modify and transfer select digital display components from one webpage to another or to a digital library, that may, for example be hosted on a server, or a cloud-based network. In this preferred aspect, an installed application, may be activated by a user on a digital device, such as a general use or virtual computer, tablet, or smartphone, and identify, replicate, modify and transfer select digital display components, such as text, video, images or other structure formats, from one webpage to another or to a digital library.

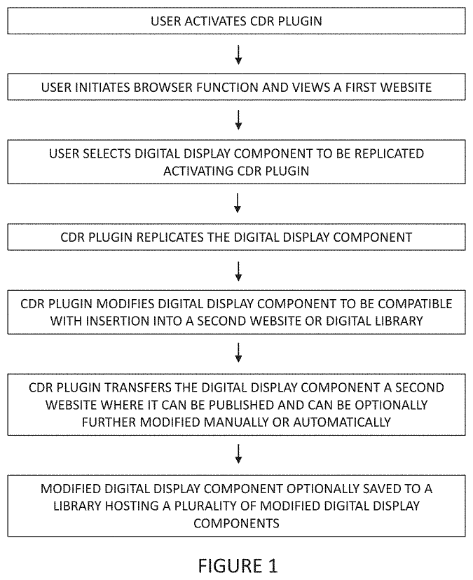

The invention further includes systems and methods for a website development platform wherein a user can rapidly select preferred DDCs from one or more websites, or from a digital library (7) of DDCs to rapidly build a new webpage or modify an existing webpage. Generally referring to FIG. 1, a user may execute an installed application on a digital device (4) and identify, replicate, optionally modify select DDCs (5) from a first webpage (2) and transfer them to a second application (8) or other API, a second webpage (3) rendered on a web browser display or as described below a digital library (7) that may also be operably linked to a second application (8) or other API, to render the DDC on said second application (8) display. Notably, in one embodiment, transferred DDCs may be rendered on a display by a second application (8) or other API or application. For purposes of this application, the term second webpage (3) is not limited in scope or number but may include a plurality of webpages from different web sites or may include different webpages that may be part of the same website or separate websites. In this embodiment, installed application may include a plugin application, and more preferably a CDR Plugin (1) that may be operably responsive to a browser application (6) on a user's digital device (4), such as a general use or virtual computer, tablet, or smartphone.

Again, as shown in FIG. 1, a user may activate a CDR Plugin (1) responsive to a browser application (6) and access a first website having a first webpage (2). A user may identify one or more DDCs (5) displayed on said first webpage (2). A user may then activate a CDR Plugin (1) to identify the DDC (5), for example through an “inspect element” application of the CDR Plugin (1). Once identified, the CDR Plugin (1) may identify the underlying code, such as html, css, javascript etc. . . . ), or digital structure of the DDC (5), and further extract a replicated version of the DDC (5).

As shown in FIG. 1, a replicated DDC (5A) may be directly transferred to, and displayed on a second website (3), which in a preferred embodiment is in an unpublished virtual or staged environment. In this embodiment, the DDC may be directly replicated and then optionally subject to further modification prior to publication. In alternative embodiments, a CDR Plugin (1) may identify a selected DDC (5) and automatically input new parameters of data into the DDC's structure. For example, in the embodiment shown in FIG. 1, a CDR Plugin (1) may identify a selected DDC (5), in this case a webpage footer with various hierarchical hyperlinks that may correspond to traditional applications, such as contacts, terms of service, biographical information, product information or classes and the like. Once identified, the CDR Plugin (1) may replicate just the displayed elements of the DDC (5), for example with the hyperlinks removed. While in alternative embodiments the CDR Plugin (1) may replicate the displayed elements of the DDC (5) and underlying hyperlinks.

In still further embodiments, the CDR Plugin (1) may replicate the displayed elements of the DDC (5) and automatically replace the underlying hyperlinks with a set of new customized hyperlinks that may be autogenerated by the CDR Plugin (1) or input by the user through the CDR Plugin (1) or other applicable program or application programming interface (API). In yet further embodiments, the CDR Plugin (1) may replicate all or a portion of the DDC (5) and display them on a second website wherein any embedded hyperlinks are maintained. In this configuration, a user may replicate a portion of a first webpage (2) and quickly display it to a second website while maintaining the hyperlinks of the first webpage (2) allowing a user to quickly expand, for example a linked e-commerce DDC across multiple websites. In this configuration, a linked e-commerce DDC may be presented one or more additional websites, for example through a sponsored section on the webpage, or as a digital advertisement, such as a retargeted ad directed to a user based on their web history and the like. A linked DDC may be modified to identify its source, such as with a logo or other corporate source identifier and the like.

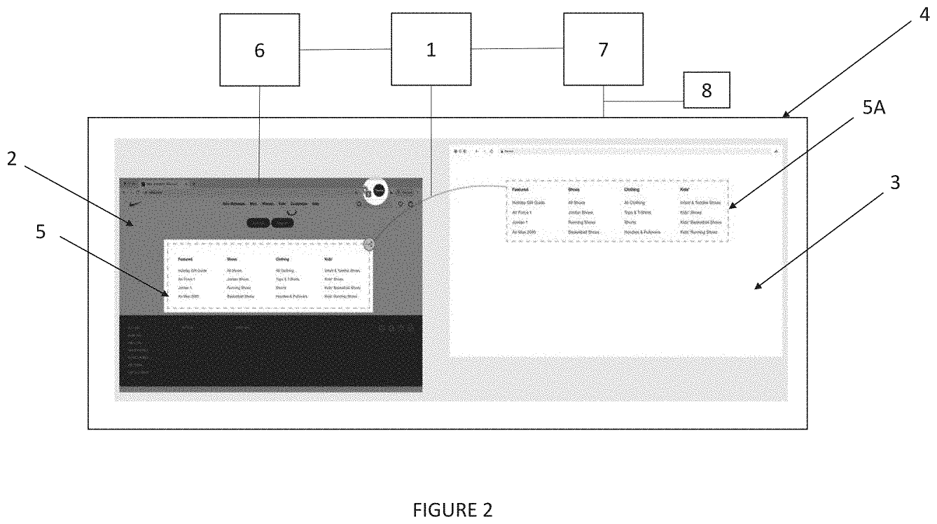

Referring again to FIG. 2, the CDR Plugin (1) of the invention may be operably linked to a digital library (7), In this preferred embodiment, as noted above, a user may activate a CDR Plugin (1) of the invention to identify and replicate and optionally transform a DDC (5) and transfer the DDC (5) to a digital library (7) which may be a physical server-based network, or a cloud-based network. One or more users may access digital copies of the DDC (5) in the digital library (7) which may further be transferred to a second webpage (3). In this embodiment, one or more users may access and modify a DDC (5) in the digital library (7), which can be added to the digital library (7) transferred to a second webpage (3).

In another embodiment, DDCs transferred to a digital library (7) of the invention may be further classified according to form, function, or other hierarchical or design identifier. In this embodiment, the digital library (7), generated by the CDR Plugin (1) of the invention may be used, in whole or in part as a website development platform wherein a user can rapidly select preferred DDCs from one or more websites, or from a digital library (7) of DDCs to rapidly build a new webpage or modify an existing webpage. The digital library (7) may include one or more templates that can be populated with various DDCs to rapidly build a new webpage. Such template may be operated through a separate executable program or installed application on a user's device (4), or through the CDR Plugin (1) of the invention.

Access and use of the CDR Plugin (1) of the invention, or the digital library (7) may be unrestricted to user's access, or restricted and provided, for example, on a subscription or per-use-fee basis. In another embodiment, the CDR Plugin (1) of the invention may automatically identify, replicate and transfer all DDCs of a webpage, or website or plurality of webpages, or websites and to a second website (3) or digital library (7) as generally described herein.

As used herein, “plugin” is a broad term, encompassing its plain and ordinary meaning, including, but not limited to, a portion of code that is constructed to communicate with a particular application (e.g., using one or more application programming interfaces (APIs) of the particular application). In one preferred embodiment, the CDR Plugin (1) of the invention may be part of, or operable with the cell-based computing system and website development platform as described in U.S. application Ser. No. 17/020,789.

As used herein, a Digital Display Component (DDC) means any element on a webpage or other digital display having an underlying readable code.

As used herein, an “inspect element” means a computer-executable command that may be linked to a user-interface allowing a user to activate a command function, such as clicking an active element, such as a DDC a webpage and showing all of the components that are linked with that active element. In this manner, a user can quickly engage an active element and identify the linked cells responsive to that element which can further be edited by the user modifying the active element.

As used herein, an “installed application” refers to a software application that has been downloaded onto an electronic device (e.g., device 2) and is ready to be launched (e.g., become opened) on the device. In some embodiments, a downloaded application becomes an installed application by way of an installation program that extracts program portions from a downloaded package and integrates the extracted portions with the operating system of the computer system. In one embodiment a browser application” or “browser” means may be an “installed application.”

As used herein, the term “open plugin,” or “executing plugin” refers to a software application or plugin with retained state information (e.g., as part of device/global internal state and/or application internal state). An open or open or executing plugin optionally can be any one of the following types of applications or plugin: an active application or plugin, which is currently displayed on a display screen of the device that the application or plugin is being used on; a background application or plugin (or background processes), which is not currently displayed, but one or more processes for the application or plugin are being processed by one or more processors; and a suspended or hibernated application or plugin, which is not running, but has state information that is stored in memory (volatile and non-volatile, respectively) and that can be used to resume execution of the application or plugin.

As used herein, the term “closed plugin” refers to software applications without retained state information (e.g., state information for closed applications is not stored in a memory of the device). Accordingly, closing an application includes stopping and/or removing application processes for the application and removing state information for the application from the memory of the device. Generally, opening a second plugin while in a first plugin does not close the first plugin. When the second plugin is displayed and the first plugin ceases to be displayed, the first plugin becomes a background plugin.

Naturally as can be appreciated, all of the steps as herein described may be accomplished in some embodiments through any appropriate machine and/or device resulting in the transformation of, for example data, data processing, data transformation, external devices, operations, and the like. It should also be noted that in some instance's software and/or software solution may be utilized to carry out the objectives of the invention and may be defined as software stored on a magnetic or optical disk or other appropriate physical computer readable media including wireless devices and/or smart phones. In alternative embodiments the software and/or data structures can be associated in combination with a computer or processor that operates on the data structure or utilizes the software. Further embodiments may include transmitting and/or loading and/or updating of the software on a computer perhaps remotely over the internet or through any other appropriate transmission machine or device, or even the executing of the software on a computer resulting in the data and/or other physical transformations as herein described.

Certain embodiments of the inventive technology may utilize a machine and/or device which may include a general purpose computer, a computer that can perform an algorithm, computer readable medium, software, computer readable medium continuing specific programming, a computer network, a server and receiver network, transmission elements, wireless devices and/or smart phones, internet transmission and receiving element; cloud-based storage and transmission systems, software updateable elements; computer routines and/or subroutines, computer readable memory, data storage elements, random access memory elements, and/or computer interface displays that may represent the data in a physically perceivable transformation such as visually displaying said processed data. In addition, as can be naturally appreciated, any of the steps as herein described may be accomplished in some embodiments through a variety of hardware applications including a keyboard, mouse, computer graphical interface, voice activation or input, server, receiver and any other appropriate hardware device known by those of ordinary skill in the art.

A “processor,” “processor system,” or “processing system,” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary”, “embodiment” or “preferred embodiment” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

1. A system, comprising:
a digital device having a processor system configured to execute an application, wherein said application is a customized digital replication and transfer system comprising:
a processing system;
a memory configured to store a browser application and a plugin that interfaces with the browser application, wherein upon being activated and executed by the processing system, the plugin is configured to:
identify a digital display component (DDC) of a first webpage rendered within a browser window;
replicate said DDC;
transfer said DDC to a second application, a second webpage rendered within a browser window, or a digital library; and
modify said DDC;
wherein said plugin is configured to execute said functions in a virtual environment; and
publish said DDC to a one or more webpages.

2. The system of claim 1, wherein said digital device comprises a general use computer, a tablet, a smartphone, or a virtual computer.

3. The system of claim 1, wherein said plugin comprises a Customizable Digital Replication (CDR) plugin.

4. The system of claim 1, wherein said DDC of a first webpage comprises a DDC having one or more hyperlinks.

5. The system of claim 4, wherein said hyperlinks are preserved, disabled, or replaced.

6. (canceled)

7. The system of claim 3, wherein said CDR plugin automatically modifies said DDC, or allows a user to manually modify said DDC.

8. The system of claim 3, wherein said CDR plugin inserts said DDC into a template, which may be stored in said digital library or said digital device.

9. The system of claim 1, wherein a user may access said digital library and modify said DDC.

10. The system of claim 1, wherein said DDC is replicated on a plurality of webpages.

11. The system of claim 1, wherein said second application comprises an application programming interface (API) or CDR plugin.

12. A method comprising:
establishing digital device having a processor system configured to execute an application, wherein said application is a customized digital replication and transfer system configured to execute the following steps:
initiating a processing system;
activating a browser application and a plugin that interfaces with the browser application, wherein upon being activated and executed by the processing system, the plugin performs the following functions:
identifying a digital display component (DDC) of a first webpage rendered within a browser window;
replicating said DDC;
transferring said DDC to a second application, a second webpage rendered within a browser window, or a digital library;
modifying said DDC;
wherein said plugin is configured to execute said steps in a virtual environment; and
publishing said DDC to a one or more webpages.

13. (canceled)

14. The method of claim 12, wherein said plugin comprises a CDR plugin.

15. The method of claim 12, wherein said DDC of a first webpage comprises a DDC having one or more hyperlinks.

16. The method of claim 15, wherein said hyperlinks are preserved, disabled, or replaced.

17. (canceled)

18. The method of claim 14, wherein said CDR plugin automatically modifies said DDC, or allows a user to manually modify said DDC.

19. The method of claim 14, wherein said CDR plugin inserts said DDC into a template, which is stored in said digital library or said digital device.

20. The method of claim 12, wherein a user may access said digital library and modify said DDC.

21. The method of claim 12, wherein said DDC is replicated on a plurality of webpages.

22. The method of claim 12, wherein said second application comprises an API or CDR plugin.

23. A system, comprising:
a digital device having a processor system that executes an application, wherein said application is a customized digital replication and transfer system comprising:
a processing system;
a memory storing a browser application and a plugin that interfaces with the browser application, wherein upon being activated and executed by the processing system, the plugin performs the following:
identifies a digital display component (DDC) of a first webpage rendered within a browser window;
replicates said DDC;
transfers said DDC to a second application, a second webpage rendered within a browser window, or a digital library; and
publishing said DDC to a one or more webpages.
